(19) United States
(12) Patent Application Publication
(10) Pub. No.: US 2008/0209235 A1
(43) Pub. Date: Aug. 28, 2008

(54) POWER SWITCHING CIRCUIT

(75) Inventors: Kun-Fu Chen, Taipei (TW); Chung-Hua Chiao, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: Inventec Corporation, Taipei (TW)

(21) Appl. No.: 11/679,636

(22) Filed: Feb. 27, 2007

(51) Int. Cl. G06F 1/00

(52) U.S. Cl. 713/300

(57) ABSTRACT

A power switching circuit includes a flip-flop for receiving an abnormal power-off signal output by shutdown software of an electronic device, and outputting a trigger signal when a power supply of the electronic device is in an abnormal shutdown status and the abnormal power-off signal. The power switching circuit further includes a switching device for receiving a first control signal indicating that the backup battery is providing power and a second control signal indicating that the power supply is providing power, and outputting a backup battery power supply signal when the abnormal power-off signal is transmitted from the flip-flop or a power supply signal when the abnormal power-off signal is not transmitted from the output end of the flip-flop. The power switching circuit further includes a voltage regulator device for switching the backup battery or a power supply to provide power.

### BACKGROUND OF THE INVENTION

1. Field of the Invention

This invention relates to power switching circuits, and more particularly, to a power switching circuit for switching a backup battery to provide powers in case of power interruption of mains supply.

2. Description of Related Art

A power supply is of vital importance for an electronic device. Without receiving any power, the electronic device, even if having varieties of powerful functions, performs nothing. Therefore, in addition to the capability to receiving the mains supply, an important electronic device is generally provided with a backup battery and is capable of receiving the power provided by the backup battery in case of power interruption of the mains supply.

For example, a storage server, during a data storage process, does not store data in a disk immediately, but in a cache in advance. In order to ensure that the data are still stored in the cache in case of power interruption of mains supply, the storage server is provided with a backup battery, which provides power to the storage server in case of the power interruption of the mains supply, such that the data stored in the cache will not vanish. Therefore, the backup battery plays a dominant role in the storage server.

FIG. 1 is a block diagram of a backup battery 1 and a power switching circuit according to the prior art. The power switching circuit switches the backup battery with a power supply (not shown), which transforms the AC mains supply into a 12V DC voltage. A second voltage regulator device (VRD) 12 transforms the 12V DC voltage into a 2.55V DC voltage, which is far smaller than the 12V DC voltage and is suitable for the storage server.

When the mains supply provides unstable powers or is interrupted, the storage server emits a first signal S1 to actuate the backup battery 1 and a second signal S2 to actuate a power supply route for the backup battery 1 and cut off another power supply route for the power supply. A switching component 13 acts as a control medium for the actuation of the power supply route for the backup battery 1. The switching component 13 is a MOSFET, by which the power supply route for the backup battery 1 is actuated and the another power supply route for the power supply is cut off. In other words, the switching component 13 controls the storage server to receive power either from the backup battery 1 or from the power supply.

The first signal S1 emitted by the storage server will be input to the first voltage regulator device 11, enabling the first voltage regulator device 11 to transform a 8.4V voltage into a 2.5V voltage, which is suitable for the storage server, when the mains supply is abnormal. On the contrary, the storage server does not emit the first signal S1 to the first voltage regulator device 11 when the mains supply is normal, and the first voltage regulator device 11 does not transform the 8.4V voltage and the backup battery 1 does not provide power (does not perform a discharging process). The storage device then provides the 12V voltage to the charging/discharging circuit 10 to charge the backup battery 1. As a result, when the mains supply is abnormal, the storage server can still operate with the power provided by the backup battery 1.

Although the storage server can still receive the power provided by the backup battery 1 when the mains supply is abnormal by the use of the power switching circuit connected between the backup battery 1 and the power supply, this scheme still encounters the following problems. The first one is that the first signal S1 and second signal S2 emitted by the storage server are hard to coordinate with each other. For instance, when the mains supply is abnormal, the storage server emits the second signal S2 to control the switching component 13 to actuate the power supply route of the backup battery 1 and cut off the another power supply route of the power supply, but if the storage server fails to emit the first signal S1 immediately, the first voltage regulator device 11 cannot transform the 8.4V voltage output from the backup battery 1 into the 2.5V voltage in time. The second one is that the switching component 13 is controlled not only by the second signal S2, but also by voltages transmitted from the backup battery 1 and the power supply and transformed by the first and second voltage regulator devices 11 and 12. In practice, because the switching component 13 needs a specific voltage to operate, but the first voltage regulator device 11 outputs the 2.5V voltage while the second voltage regulator device 12 outputs a 2.55V voltage unequal to the 2.5V voltage, data should have been stored in the storage server probably are missed or stored in wrong addresses. The third one is that the power switching circuit of the prior art has to use the first voltage regulator device 11 as well as the second voltage regulator device 12, and has a high hardware cost.

Therefore, how to provide a power switching circuit having the advantages of low cost and stable data storage to solve the problems of the power switching circuit of the prior art has becoming one of the most urgent issues in the art.

### SUMMARY OF THE INVENTION

In views of the above-mentioned problems of the prior art, it is a primary objective of the present invention to provide a power switching circuit applicable to an electronic device having a backup battery and a power supply, for switching the backup batter as a power source when mains supply is abnormal, so as to stabilize the power source and ensure the correction of data stored in a data storage unit.

It is another objective of the present invention to provide a power switching circuit, which is applicable to an electronic device having a backup battery and a power supply, and has a low hardware cost.

To achieve the above-mentioned and other objectives, a power switching circuit is provided according to the present invention. The power switching circuit is applicable to an electronic device having a backup battery, a power supply and shutdown software outputting status signals according to a normal shutdown status and a sleep status of the electronic device. The power switching circuit includes a flip-flop having a signal receiving end for receiving an abnormal power-off signal output by the shutdown software, a trigger signal end and an output end, the trigger signal end outputting a trigger signal when the power supply is in an abnormal shutdown status, to enable the output end to output the abnormal power-off signal received by the signal receiving end; a switching device having a first input end for receiving a first control signal indicating that the backup battery is providing power, a second input end for receiving a second control signal indicating that the power supply is providing power, a selection end electrically connected to the output end of the flip-flop, and a control signal end, the selection end enabling the control signal end to output a backup battery power supply signal when receiving the abnormal power-off signal transmitted from the output end of the flip-flop or enabling the control signal end to output a power supply signal when having not received the abnormal power-off signal transmitted from the output end of the flip-flop; and a voltage regulator device for receiving voltages transmitted from the backup battery and the power supply, and for switching the backup battery or the power supply as a power source of the electronic device according to the backup battery power supply signal or the power supply signal transmitted from the control signal end of the switching device respectively.

According to the preferred embodiment, the trigger signal end of the flip-flop is electrically connected to a status circuit composed of a logic gate and a filtering circuit, the logic gate having two input ends and the output end, one of the input ends being electrically connected to the power supply for receiving a power supply signal transmitted from the power supply, the other of the input ends receiving output signals filtered by the filtering circuit, the filtering circuit filtering the power supply signal, the output end being electrically connected to the trigger signal end of the flip-flop.

In summary, the power switching circuit of the present invention can switch the backup battery as a power source with the power supply cannot provide power normally, so as to protect an operating electronic device from being damaged and data from being missed when an unexpected power interruption occurs. Moreover, because the power switching circuit comprises the multiplexer and the D flip-flop and adopts the S5 mode provided by the ACPI, the timing for switching power sources is accurate and the electronic device can therefore operate stably. Further, the power switching device of the present invention comprises only one voltage regulator device and has a low hardware cost.

### BRIEF DESCRIPTION OF DRAWINGS

The invention can be more fully understood by reading the following detailed description of the preferred embodiments, with reference made to the accompanying drawings, wherein:

FIG. 1 is block diagram of a backup battery and a power switching circuit according to the prior; and

FIG. 2 is a block diagram of a backup battery and a power switching circuit of the preferred embodiment according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

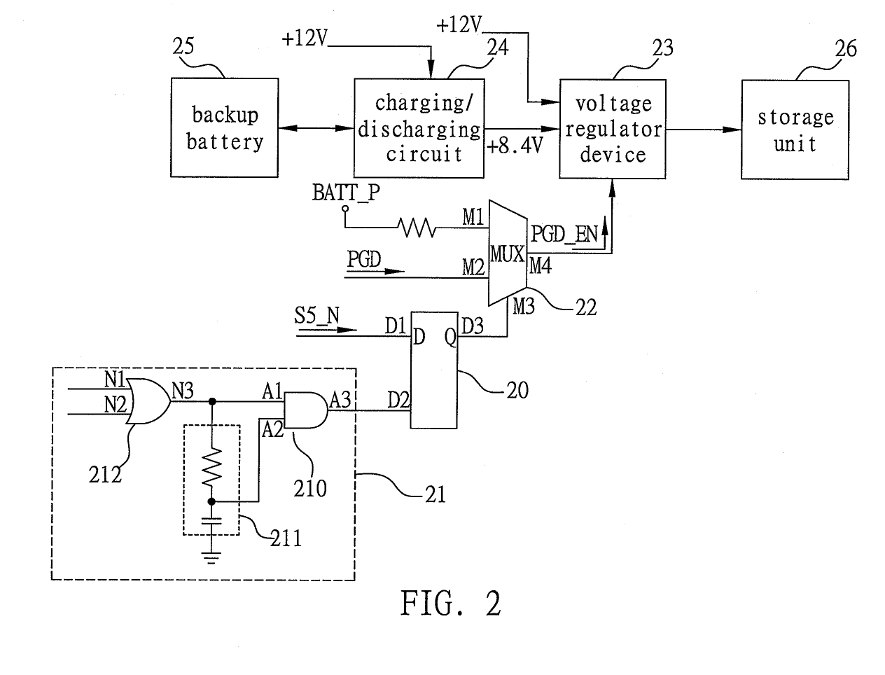

Please refer to FIG. 2, which is a block diagram of a backup battery 25 and a power switching circuit of the preferred embodiment according to the present invention. The power switching circuit is applicable to an electronic device having the backup battery 25, a power supply and shutdown software. The electronic device is switched to receive power provided by the backup battery 1 upon the interruption of power provided by the power supply (for instance, the power supply cannot receive any power provided by the mains supply), to solve the problem that an unexpected interruption of power is likely to damage the operating electronic device or ruin the processing data.

According to the preferred embodiment, the electronic device is a storage server, and the shutdown software has an advanced configuration and power interface (ACPI). In addition to the interruption of power of the power supply, the power switching circuit of the present invention switches the power supply to the backup battery 25 further according to an S5 mode provided by the ACPI.

The power switching circuit of the present invention comprises a D flip-flop 20, a status circuit 21, a switching device 22 such as a multiplexer, a voltage regulator device 23 and a charging/discharging circuit 24.

The D flip-flop 20 has a signal receiving end D1 for receiving an abnormal power-off signal S5_N output by the ACPI, a trigger signal end D2 for receiving a trigger signal emitted when the power supply is in an abnormal shutdown status, and an output end D3. According to the preferred embodiment, the trigger signal has a high voltage level, enabling the D flip-flop 20 to output at the output end D3 the abnormal power-off signal S5_N received by the receiving end D1. That the power supply is in the abnormal shutdown status means that the storage server is shutdown before completing the S5 mode provided by the ACPI. The S5 mode means that the storage server has all the data stored before being shutdown. For example, the storage server stores data stored in a register unit (not shown) into a storage unit 26, such that the data processed and stored during a previous power-on process will not miss and can be used for further processing during a next power-on process. According to the preferred embodiment, the storage unit 26 and the register unit are, but are not limited to, a hard disk and a cache respectively.

A status circuit 21 is electrically connected to the trigger signal end D2 of the D flip-flop 20. The status circuit 21 comprises an AND gate 210 and an RC filtering circuit 211. A first input end A1 of the AND gate 210 is electrically connected to the power supply (not shown). According to the preferred embodiment, the first input end A1 of the AND gate 210 is electrically connected to an output end N3 of a NOR gate 212. A first and second input ends N1 and N2 of the NOR gate 212 are electrically connected to a first and second power supplies (not shown) respectively, both of which are used for providing voltage signals. When the first power supply is malfunctioned, the second power supply will be switched to provide power.

When one of the two power supplies is interrupted to further provide power, that is the first or second input end N1 or N2 receiving a low level signal (i.e. a logic signal 0), the output end N3 outputs a high level signal (i.e. a logic signal 1) and transmits the high level signal to the first input end A1 of the AND gate 210. At the same time, the RC filter circuit 211 filters signals output at the output end N3 of the NOR gate 212 for any glitch signals, allowing the AND gate 210 to operate according to the signals output at the output end N3 of the NOR gate 212 and signals filtered by the RC filtering circuit 211, to obtain a high level signal (i.e. the logic signal 1), and to trigger the output end D3 of the D flip-flop 20 to output the abnormal power-off signal S5_N received by the signal receiving end D1.

Note that a power switching circuit of the present invention can use other electronic component having equivalent characteristics to the D flip-flop 20 to receive the abnormal power-off signal S5_N output by the shutdown software and timely output the abnormal power-off signal S5_N.

The multiplexer 22 comprises a first input end M1, a second input end M2, a selection end M3 and a control signal end M4. The first input end M1 receives a control signal BATT_P indicating that the backup battery 25 is providing power. The second input end M2 receives another control signal PGD indicating that the power supply is providing power. The selection end M3 is electrically connected to the output end D3 of the D flip-flop 20 and enables the control signal end M4 to output a backup battery power supply signal according to the abnormal power-off signal S5_N transmitted from the output end D3 of the D flip-flop 20 or to output a power supply signal PGD_EN when having not received the abnormal power-off signal S5_N.

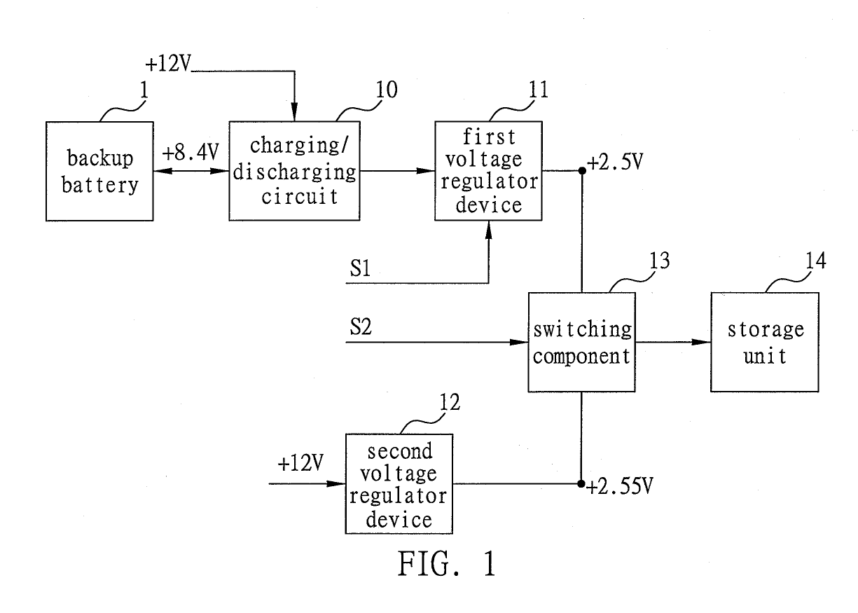

The voltage regulator device 23 receives voltages transmitted from the backup battery 25 and the power supply alternatively, and transforms the voltages of the backup battery 25 or the power supply according to the backup battery power supply signal or the power supply signal PGD_EN transmitted from the control signal end M4 of the multiplexer 22 into another voltage as a power source of the storage server. Since a charging/discharging circuit 24 has the same functions and operation principles as the charging/discharging circuit 10 shown in FIG. 1, further description hereby omitted.

Note that a power switching circuit of the present invention can use other electronic component having equivalent characteristics to the multiplexer 22 to output the power supply signal as a power source switching reference for the voltage regulator device 23.

In summary, the power switching circuit of the present invention can switch the backup battery as a power source with the power supply cannot provide power normally, so as to protect an operating electronic device from being damaged and data from being missed when an unexpected power interruption occurs. Moreover, because the power switching circuit comprises the multiplexer and the D flip-flop and adopts the S5 mode provided by the ACPI, the timing for switching power sources is accurate and the electronic device can therefore operate stably. Further, the power switching device of the present invention comprises only one voltage regulator device and has a low hardware cost.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A power switching circuit applicable to an electronic device having a backup battery, a power supply and shutdown software outputting status signals according to a normal shutdown status and a sleep status of the electronic device, the power switching circuit comprising:
a flip-flop having a signal receiving end for receiving an abnormal power-off signal output by the shutdown software, a trigger signal end and an output end, the trigger signal end receiving a trigger signal emitted when the power supply is in an abnormal shutdown status and enabling the output end to output the abnormal power-off signal received by the signal receiving end;
a switching device having a first input end for receiving a first control signal indicating that the backup battery is providing power, a second input end for receiving a second control signal indicating that the power supply is providing power, a selection end electrically connected to the output end of the flip-flop, and a control signal end, the selection end enabling the control signal end to output a backup battery power supply signal when receiving the abnormal power-off signal transmitted from the output end of the flip-flop or enabling the control signal end to output a power supply signal when having not received the abnormal power-off signal transmitted from the output end of the flip-flop; and
a voltage regulator device for receiving voltages transmitted from the backup battery and the power supply, and for switching the backup battery or the power supply as a power source of the electronic device according to the backup battery power supply signal or the power supply signal transmitted from the control signal end of the switching device respectively.

2. The power switching circuit of claim 1, wherein the electronic device is a storage server, the shutdown software has an advanced configuration of power interface (ACPI), and the abnormal shutdown status means that the storage server is shutdown before completing an S5 mode provided by the ACPI.

3. The power switching circuit of claim 2, wherein when voltage regulator device actuates the backup battery to provide power according to the backup battery power supply signal transmitted from the selection end of the switching device, the storage server stored data in a register unit to a storage unit.

4. The power switching circuit of claim 3, wherein the register unit is a cache, and the storage unit is a disk.

5. The power switching circuit of claim 1, wherein the trigger signal end of the flip-flop is electrically connected to a status circuit composed of a logic gate and a filtering circuit, the logic gate having two input ends and the output end, one of the input ends being electrically connected to the power supply for receiving a power supply signal transmitted from the power supply, the other of the input ends receiving output signals filtered by the filtering circuit, the filtering circuit filtering the power supply signal, the output end being electrically connected to the trigger signal end of the flip-flop.

6. The power switching circuit of claim 5, wherein the filtering circuit is composed of a resistor and a capacitor.

7. The power switching circuit of claim 1, wherein the flip-flop is a D flip-flop.

8. The power switching circuit of claim 1, wherein the switching device is a multiplexer.

9. The power switching circuit of claim 8, wherein the multiplexer is a two-to-one multiplexer.
